(19) United States
(12) Patent Application Publication
(10) Pub. No.: US 2005/0281352 A1
(43) Pub. Date: Dec. 22, 2005

(54) Spectrally efficient pulse shaping method

(76) Inventor: Vlad Mitlin, San Diego, CA (US)

Correspondence Address: Vlad Mitlin, 10329 Azuaga St 263, San Diego, CA, 92129, US

(21) Appl. No.: 10/871,064

(22) Filed: Jun. 21, 2004

(51) Int. Cl. H04L 27/04

(52) U.S. Cl. 375/295

(57) ABSTRACT

There is provided a method of generating pulses with enhanced bandwidth occupancy. A bandwidth occupancy criterion in the form of a variational problem is introduced. This problem has an analytical solution yielding an optimum termed the SO-pulse. A low-complexity approximation of this pulse is given by the logistic equation and is termed the L-pulse. Finally, a new trapezoidal pulse termed the phi-pulse that provides an optimum for the bandwidth occupancy criterion on a subclass of pulses generated by passing a unit area impulse through a sequence of sliding summers is introduced. Simulations of BER tests show that these new pulses are superior to the standard ones used in digital communications.

### FIELD OF THE INVENTION

The present invention relates to pulse shaping for digital communications and, more particularly, to methods of generating low-complexity, spectrally efficient pulses for digital communications.

### BACKGROUND OF THE INVENTION

In digital communications the data transmission is performed, in the most basic PAM (pulse amplitude modulation) scenario, by creating a train of identical pulses and multiplying each pulse by a number representing a symbol of an information-bearing sequence to be transmitted. The classical Shannon theory establishes a relationship between the data rate of a communication channel, the signal power, and the bandwidth. Specifically, both an increase in the power and the bandwidth yield an increase in the channel data rate. An ideal situation would be if one were allowed to increase the power of the pulse used for data transmission as well as its bandwidth as much as one desires to achieve the required data rate. Then one would transmit a sequence of very tall and narrow pulses. However, such pulses should not be used in reality, as there are severe restrictions on the power level of a pulse as well as on the bandwidth it occupies. Therefore, such a sequence has to be passed through a filter that modifies the pulse shape and, for a given energy of the pulse, reduces its effective bandwidth. Designing bandwidth-efficient pulses is an important problem, particularly in wireless applications where the bandwidth occupancy affects the total number of users in the spectral window allocated for a given service provider. Methods associated with the pulse choice are referred to as pulse shaping methods.

There are several standard methods of pulse shaping currently used. The most popular pulses are rectangular, Bartlett, Hanning, Blackman, and Hamming. Of these five pulses, the first two should be separated from the last three, the separation criterion being the processing complexity. Specifically, a rectangular pulse is created by passing a unit area impulse through a sliding summer like the one shown in FIG. 1. The Bartlett pulse is created by passing a unit area impulse through a sequence of two identical sliding summers. The complexity of circuitry associated with generating Hanning, Hamming, and Blackman pulses is substantially higher, as it also includes several multipliers.

### SUMMARY OF THE INVENTION

In accordance with the present invention, there is provided a method of generating pulses with enhanced bandwidth occupancy. A bandwidth occupancy criterion in the form of a variational problem is introduced. This problem has an analytical solution yielding an optimum termed the SO-pulse. A low-complexity approximation of this pulse is given by the logistic equation and is termed the L-pulse. Finally, a new trapezoidal pulse termed the phi-pulse is introduced. The phi-pulse provides an optimum for the bandwidth occupancy criterion on a subclass of pulses generated by passing a unit area impulse through a sequence of sliding summers. Simulations of BER tests show that these new pulses are superior to the standard ones used in digital communications.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an example of a sliding summer with five binary adders and five unit delay elements.

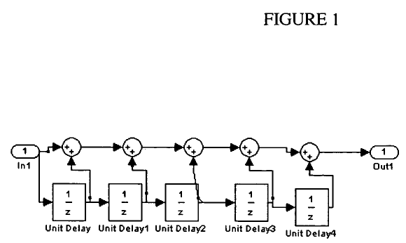

FIG. 2 is the spectral density of the Bartlett pulse.

FIG. 3 is the spectral density of the Blackman pulse.

FIG. 4 is a geometrical construction used for determining the spectral width of the Bartlett pulse.

FIG. 5 is a geometrical construction used for determining the spectral width of the Blackman pulse.

FIG. 6 is an optimum pulse shape obtained in computer simulations at p/n=0.3.

FIG. 7 is an optimum pulse shape obtained in computer simulations at p/n=0.4.

FIG. 8 is an optimum pulse shape obtained in computer simulations at p/n=0.5.

FIG. 9 is an optimum pulse shape obtained in computer simulations at p/n=0.6.

FIG. 10 is an optimum pulse shape obtained in computer simulations at p/n=0.7.

FIG. 11 is an optimum pulse shape obtained in computer simulations at p/n=1.

FIG. 12 is an optimum pulse shape obtained in computer simulations at p/n=3.

FIG. 13 is an optimum pulse shape obtained in computer simulations at p/n=10.

FIG. 14 is an optimum pulse shape obtained in computer simulations at p/n=100.

FIG. 15 is the phi-pulse at n=128.

FIG. 16 is the dependency of the base 10 logarithm of J on m at n=128.

FIG. 17 is the round-off table for calculating the m value of a phi-pulse.

FIG. 18 is a table of parameters of phi-pulses at different values of n.

FIG. 19 is a table of J values of various pulses studied at different values of n.

FIG. 20 is a table of peak-to-average power ratios for various pulses studied.

FIG. 21 is a schematic representation of the BER test simulator used.

FIG. 22 is a schematic representation of a subsystem of the simulator shown in FIG. 21 responsible for pulse generation (case of a phi-pulse is shown)

FIG. 23 is a plot showing results of BER test simulations for various pulses studied in AWGN channel with noise variance of 8; 50,000 bits transmitted.

FIG. 24 is a plot showing results of BER test simulations for various pulses studied in AWGN channel with noise variance of 12; 10,000 bits transmitted.

FIG. 25 is a plot showing results of BER test simulations for various pulses studied in AWGN channel with noise variance of 16; 10,000 bits transmitted.

FIG. 26 is the J dependence of the total number of bit errors in 10,000 bits transmitted in a BER test on AWGN channel with noise variance of 12 (diamonds) and 16 (triangles), for various pulses studied.

FIG. 27 is a plot showing the Hanning pulse (diamonds) and its SAS approximation (squares) at n=64.

FIG. 28 is a plot showing the Blackman pulse (diamonds) and its SAS approximation (squares) at n=64.

FIG. 29 is a schematic representation of a subsystem of the simulator shown in FIG. 21 responsible for pulse generation (case of an L-pulse is shown).

FIG. 30 is an initial part of an L-pulse train generated using the subsystem shown in FIG. 29.

FIG. 31 is an L-pulse generated using the subsystem shown in FIG. 29.

FIG. 32 is the spectral density of a sum of three sine waves with close frequencies obtained by using various pulses studied as windowing functions.

FIG. 33 is the spectral density of a sum of three sine waves with close frequencies obtained by using the phi-pulse as a windowing function, without quantization (“o”) and with quantization level of le-5 (“+”).

FIG. 34 is the spectral density of a sum of three sine waves with close frequencies obtained by using the SO-pulse as a windowing function, without quantization (“o”) and with quantization level of le-5 (“+”)

FIG. 35 is the spectral density of a sum of three sine waves with close frequencies obtained by using the Hanning pulse as a windowing function, without quantization (“o”) and with quantization level of le-5 (“+”).

FIG. 36 is the spectral density of a sum of three sine waves with close frequencies obtained by using the Bartlett pulse as a windowing function, without quantization (“o”) and with quantization level of le-5 (“+”).

FIG. 37 is the spectral density of a sum of three sine waves with close frequencies obtained by using the Blackman pulse as a windowing function, without quantization (“o”) and with quantization level of le-5 (“+”).

FIG. 38 is the spectral density of a sum of three sine waves with close frequencies obtained by using the L-pulse as a windowing function, without quantization (“o”) and with quantization level of le-5 (“+”).

FIG. 39 is the spectral density of a sum of three sine waves with close frequencies obtained by using the Hamming pulse as a windowing function, without quantization (“o”) and with quantization level of le-5 (“+”).

FIG. 40 is the spectral density of a sum of three sine waves with close frequencies obtained by using the raised phi-pulse as a windowing function, without quantization (“o”) and with quantization level of le-5 (“+”).

FIG. 41 is the spectral density of a sum of three sine waves with close frequencies obtained by using the raised L-pulse as a windowing function, without quantization (“o”) and with quantization level of le-5 (“+”).

FIG. 42 is the spectral density of a sum of three sine waves with close frequencies obtained by using the raised SO-pulse as a windowing function, without quantization (“o”) and with quantization level of le-5 (“+”).

For purposes of clarity and brevity, like elements and components will bear the same designations and numbering throughout the FIGURES.

### DESCRIPTION OF THE PREFERRED EMBODIMENT

Pulse Shape Optimization Criterion

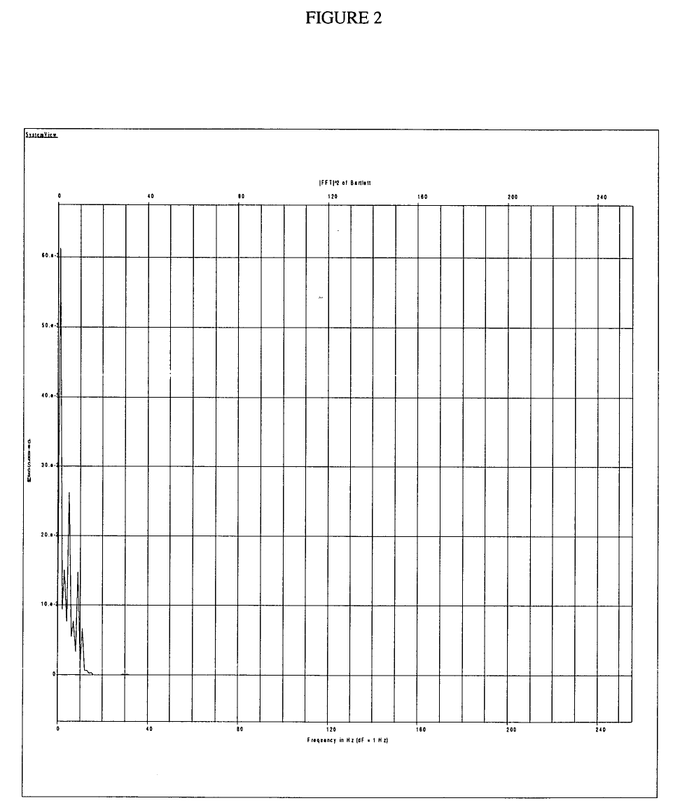

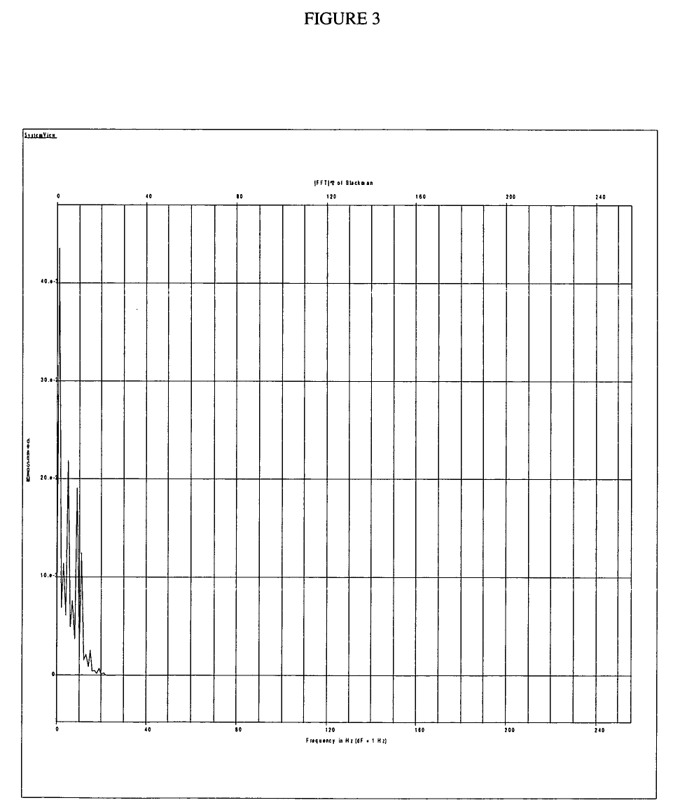

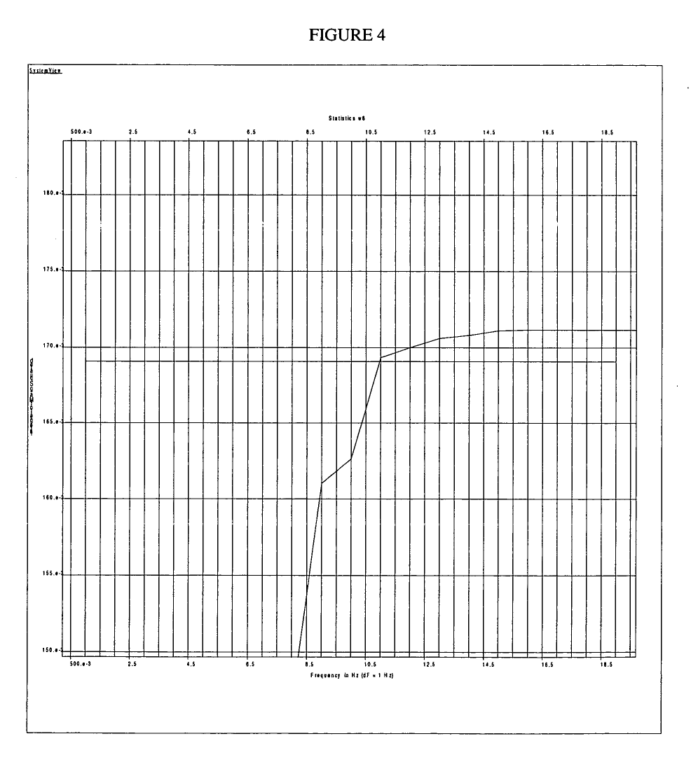

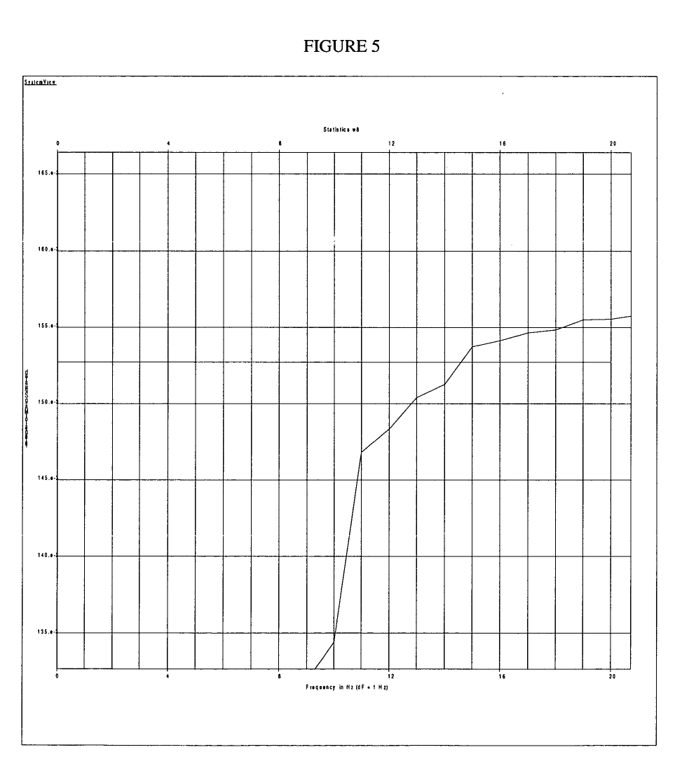

A natural requirement of a good pulse is its spectrum confinement. An intuitive notion of a spectrally confined signal comes from observing the signal spectral density. The spectral density of a good pulse should be concentrated in a relatively small vicinity of zero frequency. FIGS. 2 and 3 present the spectral densities of the Bartlett and Blackman pulses. From looking at these spectra the Bartlett pulse seems to contain a larger portion of its total energy in the same vicinity of zero frequency than the Blackman pulse. This observation can be quantified, for instance, as follows: one can integrate the spectral density from zero to a given frequency, plot the result as a function of frequency and overlay it with its mean value. The result is shown in FIGS. 4 and 5; the frequency at the point of intersection can be used as a measure of spectrum confinement. Thus, with respect to its spectrum confinement, the Bartlett pulse is better than the Blackman pulse.

The measure of spectrum confinement discussed above is termed the spectral width. The spectral width is the optimization criterion to be used below. As this quantity is a functional of the spectral density of a signal, it is more convenient to use an equivalent formulation in terms of the signal itself as follows:

$${W}^{*} = min W , W = \sqrt{J} , J = \frac{{\int }_{0}^{T} {( \frac{ⅆ s}{ⅆ t} )}^{2} ⅆ t}{{\int }_{0}^{T} {s}^{2} ⅆ t} \qquad ( 1 )$$

Eq. (1) states that J, the square of the effective bandwidth W occupied by a signal s(t) with a period of T has to be minimized. The rest of the document describes pulse shapes that are optimal with respect to the criterion (1).

It should be noted that a general expression for J is more complex. Specifically,

$$J = \frac{T {\sum }_{i = 1}^{N} {a}_{i}^{2} {\int }_{0}^{T} {( \frac{ⅆ s}{ⅆ t} )}^{2} ⅆ t - {( {\sum }_{i = 1}^{N} {a}_{i} {\int }_{0}^{T} \frac{ⅆ s}{ⅆ t} ⅆ t )}^{2}}{T {\sum }_{i = 1}^{N} {a}_{i}^{2} {\int }_{0}^{T} {s}^{2} ⅆ t} \qquad ( 2 )$$

where the summation is taken over the index i enumerating the information-bearing sequence {aᵢ}. It will be assumed in the subsequent analysis that each pulse vanishes at the ends of the interval (0,T). Then Eq. (2) reduces to a much simpler Eq. (1).
SO-pulse and L-pulse

Generally, the functional J has to be minimized for all pulses of a given area defined in the interval (0, T) and vanishing at the end points of this interval. The exact solution of the optimization problem (1) is obtained using standard methods of the calculus of variations. The optimal pulse has the following continuous representation:

$$0 \leq t \leq T \text{:} s = A sin \frac{π t}{T} \qquad ( 3 )$$

where A is the pulse magnitude. This pulse is termed the SO-pulse where SO stands for “spectrally optimal”.

A simulator was developed to study this optimization problem. Each run started with a slightly perturbed rectangular pulse shape of the height p and the width of n. At each iteration, two points from the interval (1, n) were chosen at random. The pulse value in the first point was decreased by 1, and the pulse value in the second point was increased by 1. Then, the J value was computed for the modified pulse; if the new value was smaller than the old one, the new pulse shape was processed the same way; otherwise, the proposed pulse shape was rejected. To avoid falling into a local minimum, a version of the simulated annealing method was implemented. Specifically, if the J value remained the same for a certain number of trials, the value of a local increment in the pulse shape was doubled, then tripled, and so on.

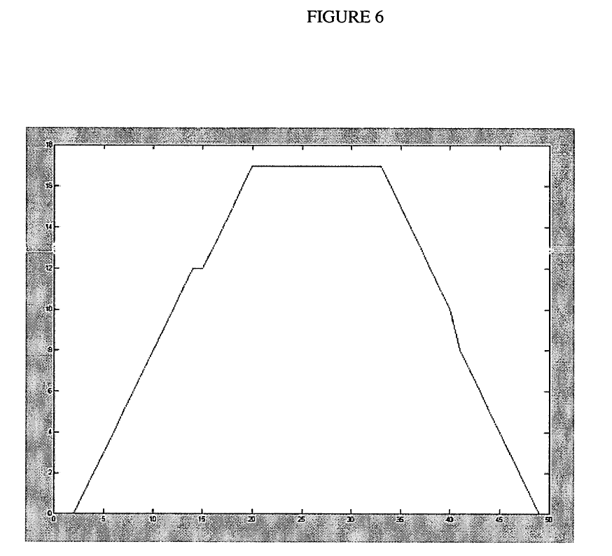

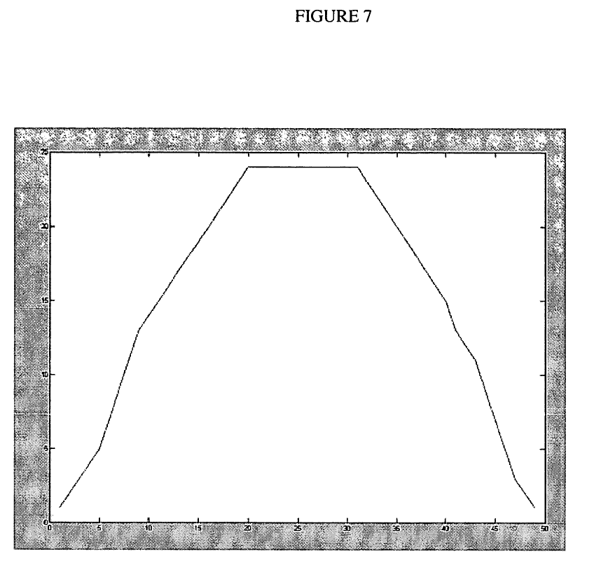

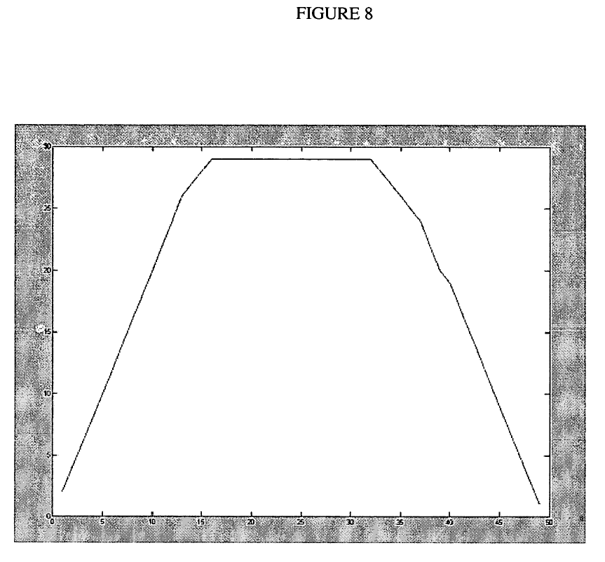

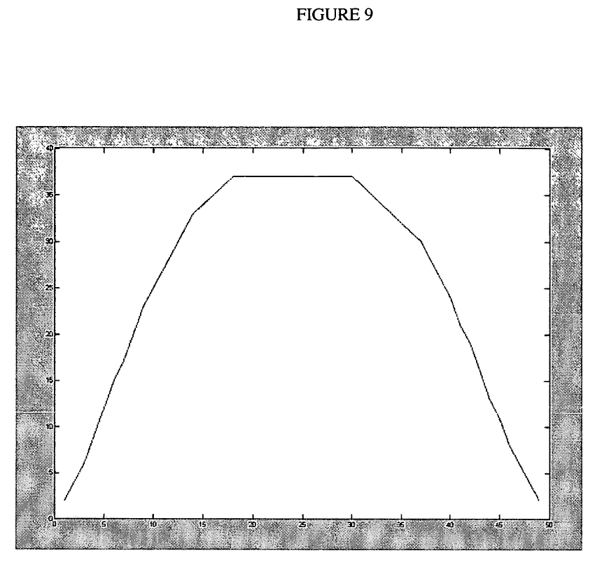

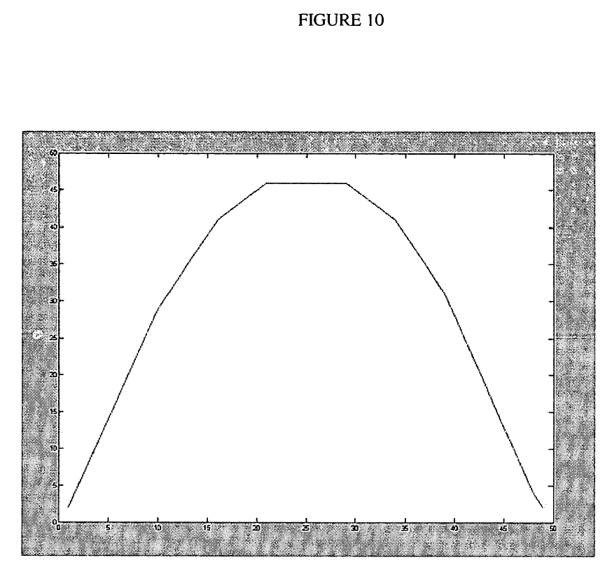

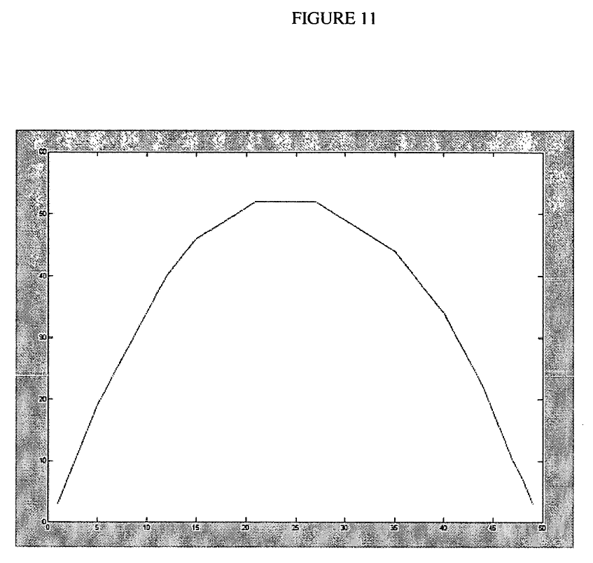

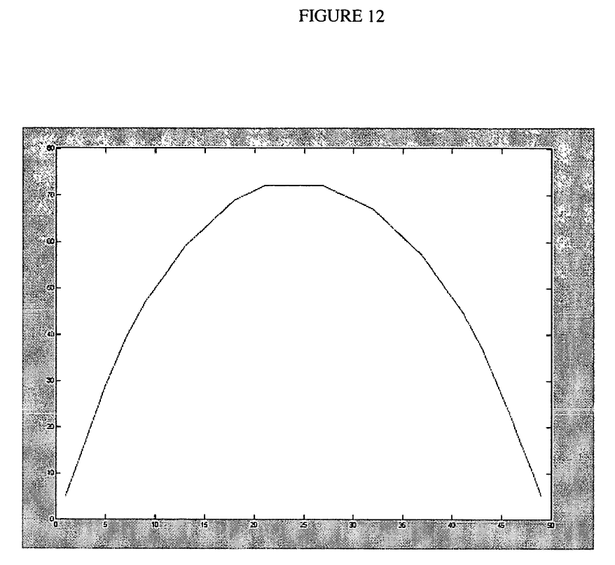

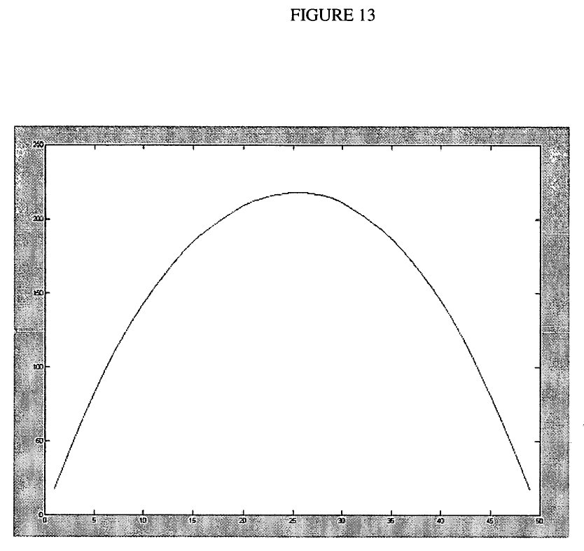

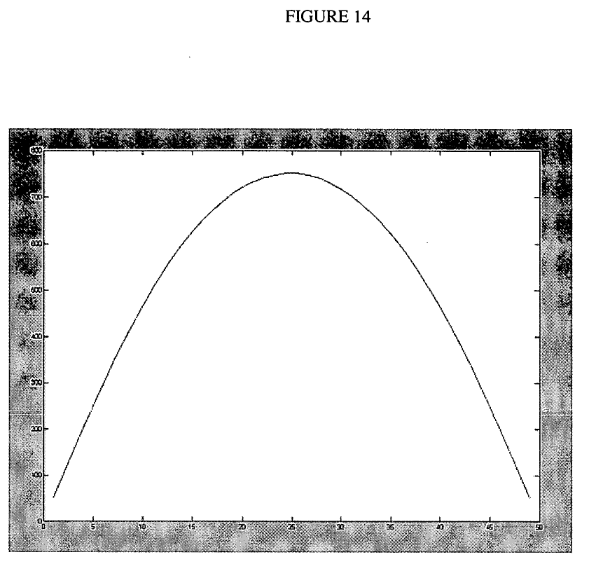

The results at n=50 are shown in FIGS. 6 through 14. The optimal shape depended on the value of the pulse area which was invariant in each run. At large p/n the optimum pulse shape looks like those shown in FIGS. 13 and 14. After the optimal pulse shapes were normalized by their maximum values, the same smooth prolate SO-pulse was obtained.

It was found that the optimal pulse shape is almost perfectly described (i.e. with the deviation of J from its optimal value not exceeding 1 percent) by the logistic equation:

$$0 \leq t \leq T \text{:} s = A \frac{4 Tt - 4 {t}^{2}}{{T}^{2}} \qquad ( 4 )$$

This pulse is termed the L-pulse where L stands for “logistic”.

At small p/n (0.3 to 0.5; FIGS. 6 to 8) the optimum would look like a symmetrical trapezoidal pulse. Further increase in p/n smoothed the corners of the optimum pulse.

Phi-pulse

Results of simulations shown above demonstrate that the narrower the class of pulses on which J is minimized (or, equivalently, the smaller the value of p/n), the more the optimal pulse shape looks trapezoidal. This section presents a theory of the pulse that minimizes Eq. (1) on a certain class of pulses. Each of these pulses is generated via passing a unit area pulse through a sequence of sliding summers (SAS). In addition, a requirement of the same processing complexity is imposed on the set of pulses on which the optimum is sought: specifically, the sum of the lengths (in samples) of all the adders in each sequence is equal to the same value n. This is a broad class of pulses: the rectangular pulse and the Bartlett pulse belong to it.

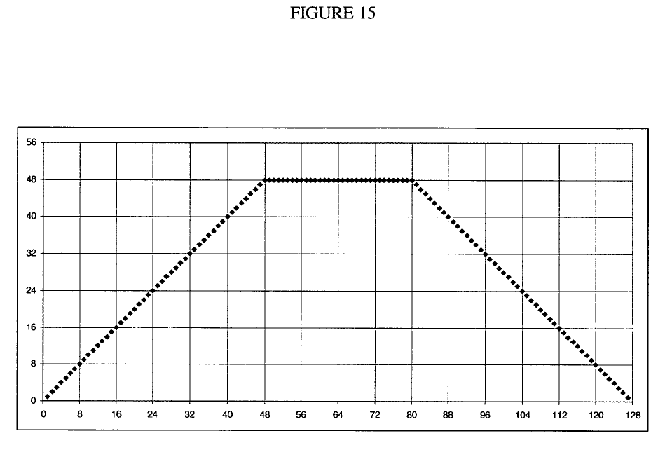

Consider the subclass of pairs of summers with the total length of n. If the length of the first sliding summer is m<n/2 the length of the second sliding summer is n−m. A typical pulse generated this way is shown in FIG. 15. It is symmetrical and trapezoidal with the height of m and the lengths of the lower base of n and upper base of n−2m+2 (here for convenience, consider the case of the sampling rate of unity). This can be formalized as follows:

$$0 \leq i \leq m \text{:} s = \frac{i}{m} \\ m < i < n - m \text{:} s = 1 \\ n - m \leq i \leq n \text{:} s = \frac{n - i}{m} \qquad ( 5 )$$

For the case considered, the expression for J in Eq. (1) can be written out explicitly in a discrete form:

$$J = \frac{2 m}{m ( m + 1 ) ( 2 m + 1 ) / 3 + {m}^{2} ( n - 2 m - 1 )} = \frac{6}{- 4 {m}^{2} + 3 nm + 1} \qquad ( 6 )$$

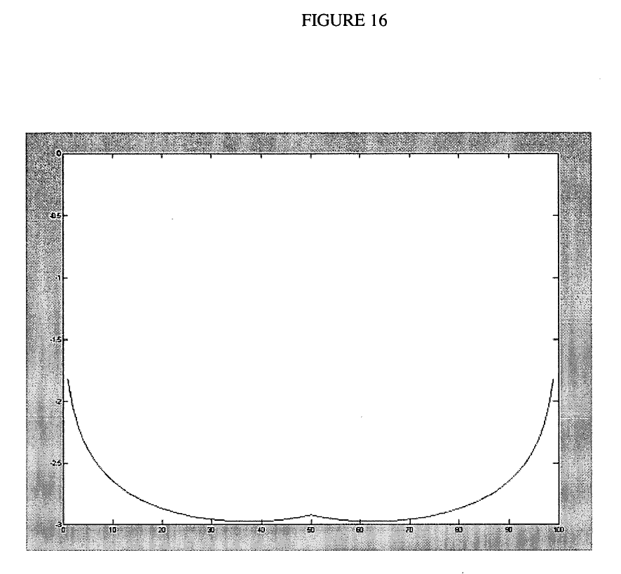

FIG. 16 shows the dependency of the base 10 logarithm of J versus m at n=128.

The denominator in Eq. (6) is maximized at
m*=3n/8 (7)

Since m is an integer, Eq. (7) has to be rewritten as:
m*=[3n/8] (8)

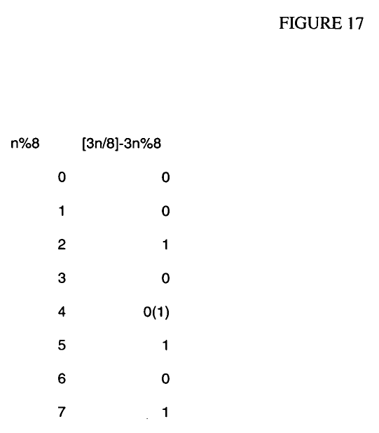

In Eq. (8) [x] denotes the closest integer to a given real number x. FIG. 17 shows how Eq. (8) works. When the remainder of dividing n by 8 is 0, 1, 3, and 6 the r. h. s. of Eq. (7) is rounded down; when this remainder is 2, 5, and 7 the r. h. s. of Eq. (7) is rounded up; finally, when this remainder is 4, the r. h. s. of Eq. (7) may be rounded up or down with the same effect, and in order to be specific it is rounded down in this case.

Introducing Eq. (7) into Eq. (6) yields the minimum value of J on the subclass considered:

$${J}^{*} = \frac{96}{9 {n}^{2} + 16} \qquad ( 9 )$$

Now it is easy to generalize the results obtained to the case of an arbitrary sampling frequency f and the pulse period T. The effective bandwidth occupied by the optimal pulse is given by the following formula:

$${W}^{*} = \sqrt{\frac{96 {f}^{2}}{9 {T}^{2} {f}^{2} + 16}} {f \to ∞}_{} \frac{\sqrt{32 / 3}}{T} \approx \frac{3.27}{T} \qquad ( 10 )$$

Compare the results obtained for the optimal trapezoidal pulse to those for the Bartlett and rectangular pulses. For the Bartlett pulse, the J value is obtained by introducing m=n/2 into Eq. (6). This yields:

$${J}^{′} = \frac{12}{{n}^{2} + 2} \qquad ( 11 )$$

Combining Eqs. (9) and (11) yields an expression for the effective bandwidth ratio of the optimal trapezoidal pulse to the Bartlett pulse, X:

$$X = \sqrt{\frac{8 {T}^{2} {f}^{2} + 16}{9 {T}^{2} {f}^{2} + 16}} {f \to ∞}_{} \sqrt{8 / 9} \approx 0.94 \qquad ( 12 )$$

In the limit of large sampling frequencies, the bandwidth reduction is about 6 percent. For the rectangular pulse, the J value is obtained by introducing m=1 into Eq. (6). This yields:

$${J}^{″} = \frac{2}{n - 1} \qquad ( 13 )$$

Combining Eqs. (13) and (9) yields an expression for the effective bandwidth ratio of the optimal trapezoidal pulse to the rectangular pulse, Y:

$$Y = 6 \sqrt{\frac{Tf - 1}{9 {T}^{2} {f}^{2} + 16}} {f \to ∞}_{} 0 \qquad ( 14 )$$

In the limit of large sampling frequencies, the ratio of bandwidth values of the optimal trapezoidal pulse to the rectangular pulse tends to zero.

FIG. 15 shows the optimal trapezoidal pulse at n=128. We termed it the phi-pulse because n/(n−m*)=1.60 is very close to the golden ratio φ=1.62. Its continuous representation is:
0≦t≦3T/8: s=8At/3T
3T/8<t<5T/8: s=A (15)
5T/8≦t≦T: s=8A/3−8At/3T

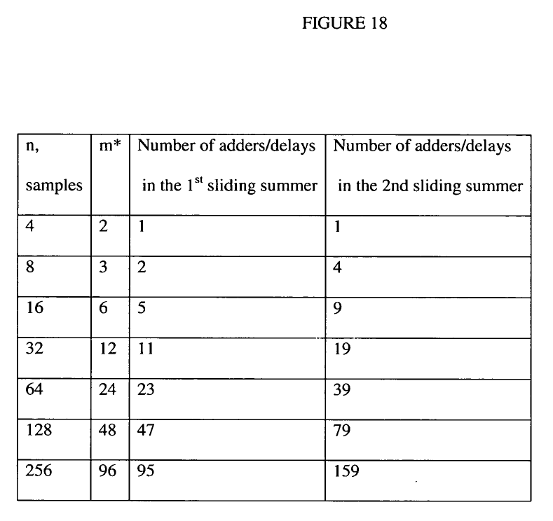

FIG. 18 shows typical parameters of the phi-pulse at n equal to the first few powers of two, including the number of binary adders and unit delay elements in each of the two sliding summers needed to generate the pulse.

The phi-pulse is optimal on the subclass of pulses generated by passing a unit area pulse through a sequence of two sliding summers. A Matlab code was written to verify the derivations; it yielded the same conclusion for n as large as 256. Naturally, the following question arises: what is the optimal pulse shape on the subclass of pulses generated by passing a unit area pulse through a sequence of more than two sliding summers with the total length of n? We could not solve this problem analytically, thus two more programs were written to determine the optimal shape when a generating sequence consisted of 3 and 4 summers. The optimal shape in these two cases was again the phi-pulse. This is verified for n as large as 256. Of course, a checkup of this statement cannot be performed for any n but analytical and numerical verifications performed indicate that the phi-pulse is optimal on the whole class of pulses considered.

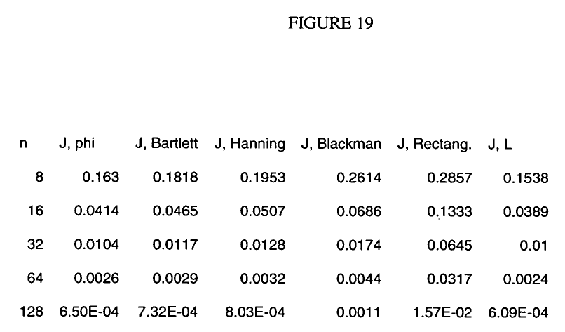

FIG. 19 presents the J values for various pulses considered in this study. Results for the SO-pulse are not presented, as they are almost identical to those of the L-pulse. In terms of spectrum confinement, the L-pulse is better than the phi-pulse which is better than the Bartlett pulse which is better than the Hanning pulse which is better than the Blackman pulse which is better than the rectangular pulse.

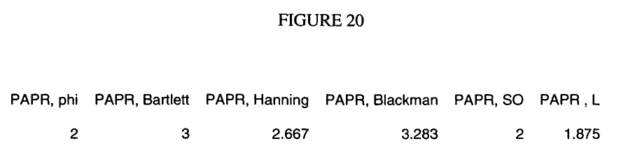

FIG. 20 is a table presenting pulse-to-average power ratios for various pulses studied. The L-pulse has the lowest PAPR, the phi-pulse and the SO-pulse are next, followed by Hanning, Bartlett, and Blackman pulses, respectively.

BER Test

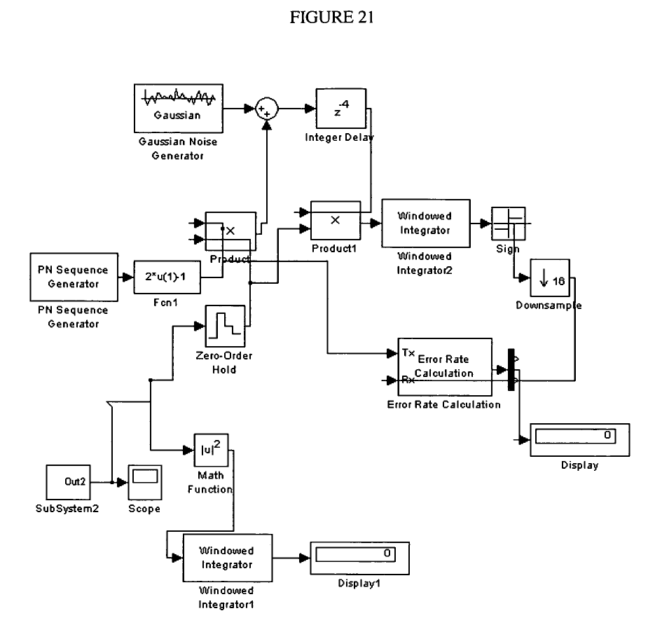

The next question to answer is how the difference in J values for two given pulses reflects in their comparative transmission properties. To answer this question Matlab simulators of the BER test were developed for each pulse considered. Such a simulator is shown in FIG. 21.

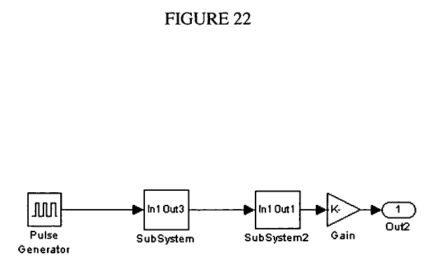

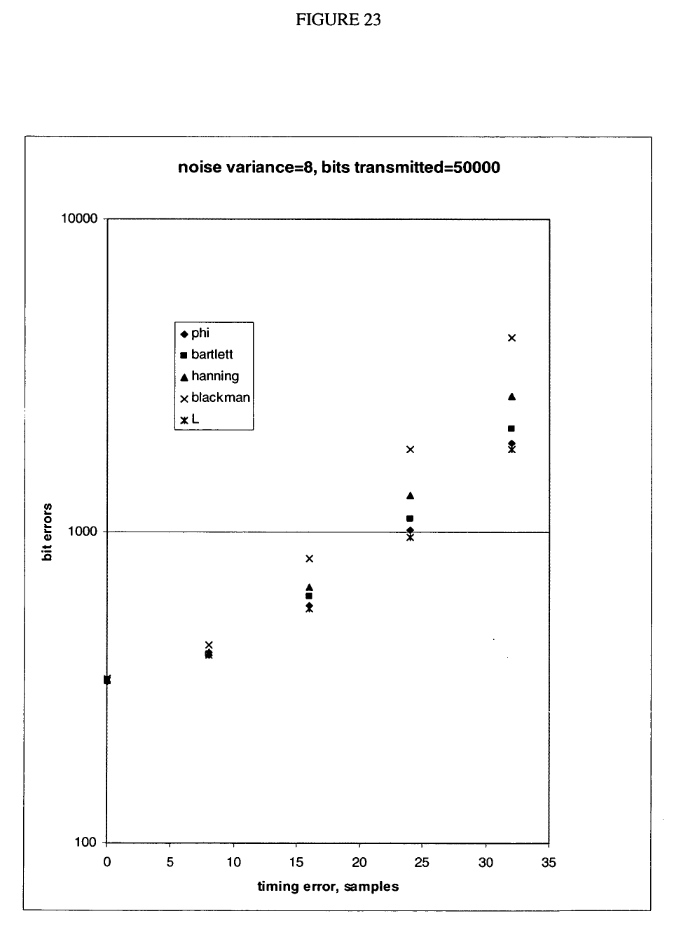

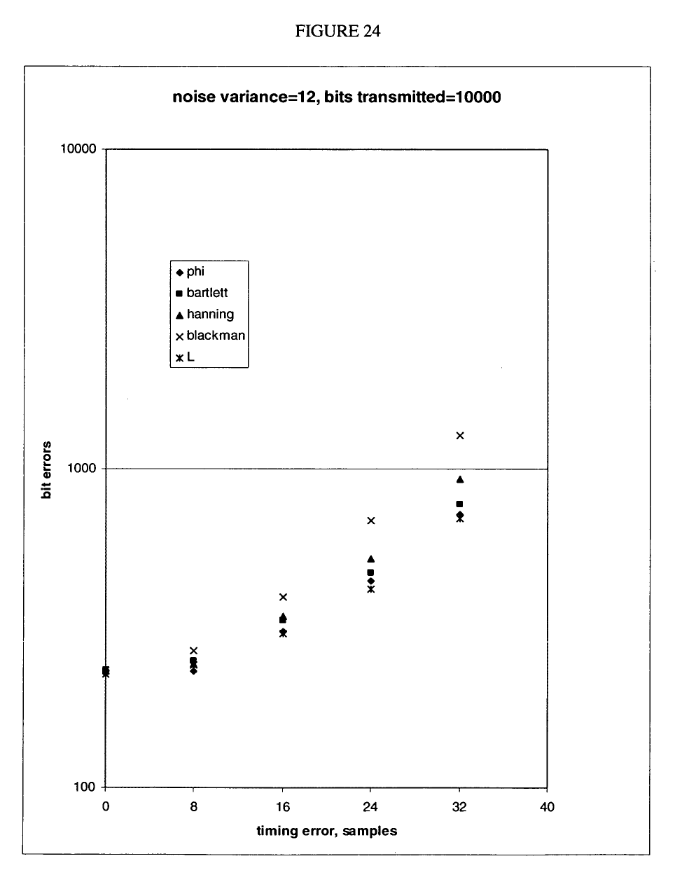

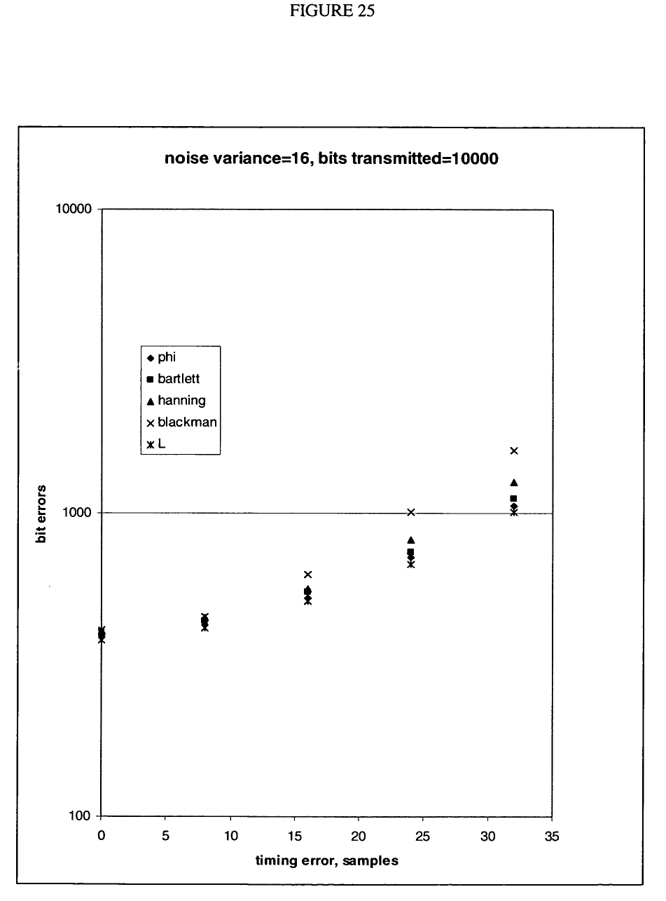

A given pulse with a period of 1 second is generated in the subsystem Out2. This subsystem is shown in more detail in FIG. 22 for the case of generating a train of phi-pulses. It consists of a unit area pulse train generator, followed by two sliding summers followed by an amplifier (gain). The pulse generated is sampled at the rate of 128 Hz and multiplied by a symbol from an information-bearing binary sequence with a rate of 1 Hz. Then it is passed through the AWGN channel. The optimal correlator type of receiver was implemented, i.e. the signal corrupted with noise is multiplied by the exact replica of the pulse and integrated over the pulse period. The result is put through a slicer, downsampled by 128, and compared to the transmitted symbol of the information-bearing sequence. To have a fair basis for comparison of the performance of different pulses, the pulse power was the same in all simulations, e.g. 0.375. Three cases were considered, e.g. the AWGN variance was equal to 8, 12, and 16. In the first case the transmission of 50,000 bits was simulated; in the other two cases—10,000 bits. Not only was the effect of noise on the BER analyzed, but also the effect of the timing error. This was done by introducing the delay element in the channel part of the simulator. The BER test was run at timing error values equal to 0, 8, 16, 24, and 32 samples, which is equivalent to 0, 1/16, ⅛, 3/16, and ¼ of the pulse period. The results are shown in FIGS. 23 to 25, respectively. These figures show that the L-pulse and the phi-pulse are superior to the Bartlett, Hanning, and Blackman pulses. This becomes apparent, as the timing error increases.

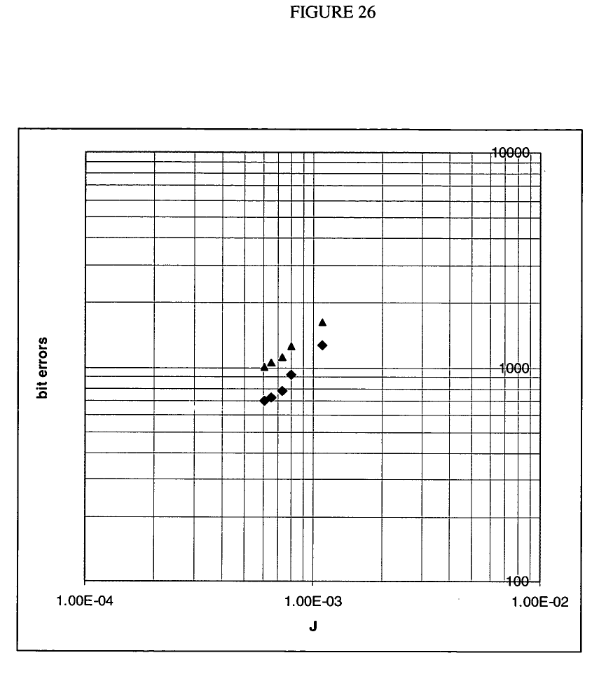

There is a strong quantitative correlation between the J value of a pulse and the BER it yields. More specifically, it was observed that for the same level of noise and the same timing error, the ratio of BERs of two pulses compared is approximately equal to the ratio of their J values, as illustrated in FIG. 26. This figure shows the number of bit errors in 10,000 bits transmitted at the timing error of ¼ of the pulse period versus the J values in the case of AWGN variance of 12 (diamonds) and 16 (triangles), respectively. The dependency in both cases is approximately linear. This allows one to propose a simple method of comparing the average BER performances, over the existing range of timing errors, of two pulses without running an actual BER test. Thus, estimating the BER of a new pulse can be done by multiplying the BER of a ‘catalogued’ pulse by the ratio of the J value of the first pulse to that of the second pulse.

Approximation of Pulses by SAS

This section describes how to approximate some pulses by sliding summer sequences (SAS). SAS were introduced earlier when the phi-pulse shape was obtained. Binary SAS are equivalent to piecewise-linear approximations, triple SAS to piecewise-quadratic, quaternary SAS to piecewise-cubic approximations, and so on. This problem is important because, as mentioned earlier, SAS are represented in hardware by low-complexity devices that do not include multipliers.

Several Matlab codes were developed for solving this problem. These codes use the following algorithm: they go through all of the SAS of a total length n trying to minimize the square deviation between a shape generated by a given SAS and the pulse shape approximated.

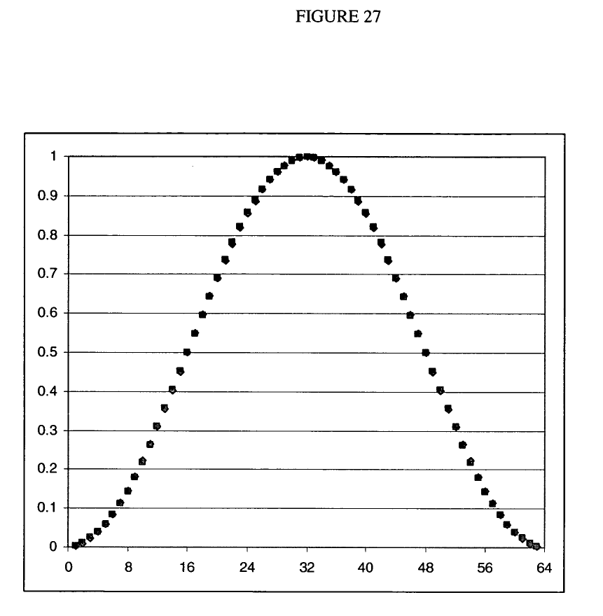

The results are impressive. FIG. 27 shows the comparison between an exact shape of the Hanning pulse and its SAS approximation at n=64. It is hard to tell where the real Hanning pulse is and where is its approximation. Apparently, the optimal approximation in this case corresponds to the following sequence of summer lengths: 12, 21, and 32. It is interesting that the increase in the number of sliding summers in the SAS from 3 to 4 or 5 does not modify this result. It is generally found that the best SAS approximation of the Hanning pulse is attained on the sequence of 3 sliding summers of the lengths approximately equal to n/2, n/3, and n/6. In other words, the optimal lengths form approximately the following proportion, 1:2:3.

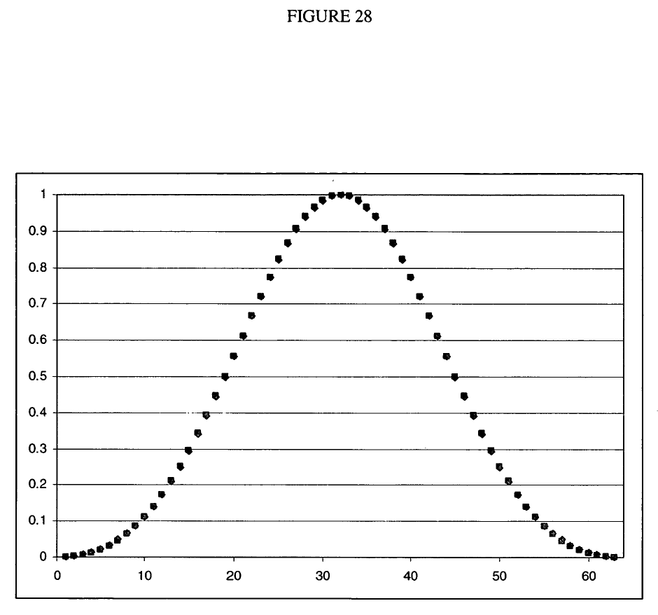

FIG. 28 shows the comparison between an exact shape of the Blackman pulse and its SAS approximation at n=64. Again, it is hard to tell where the real Blackman pulse is and where is its approximation. The optimal approximation in this case corresponds to the following sequence of adder lengths: 22, 22, 15 and 7. Here also, the increase in the number of summers in the SAS from 4 to 5 does not modify this result. Generally, it is found that the best SAS approximation of the Blackman pulse is attained on the sequence of 4 sliding summers of the lengths approximately equal to n/3, n/3, n/8, and 5n/24. The optimal lengths form approximately the following proportion, 8:8:3:5.

Of course, the best SAS approximation of L-pulse and SO-pulse is the phi-pulse.

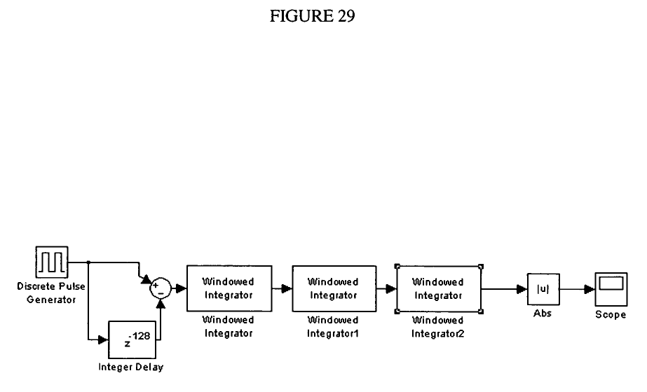

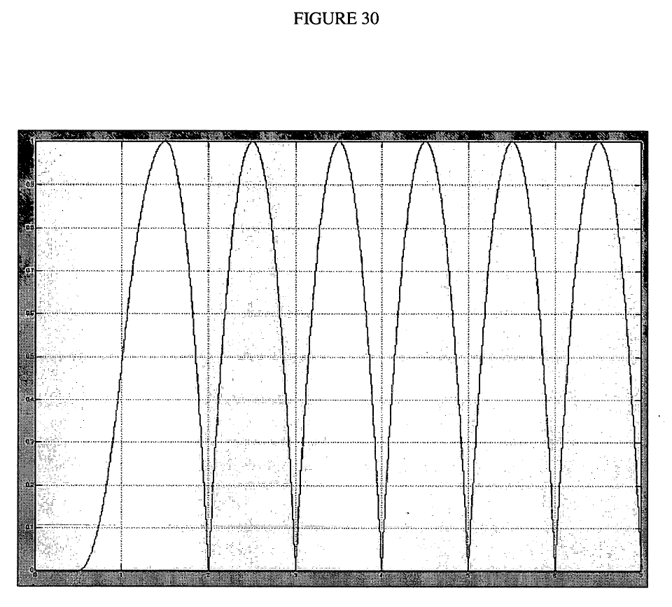

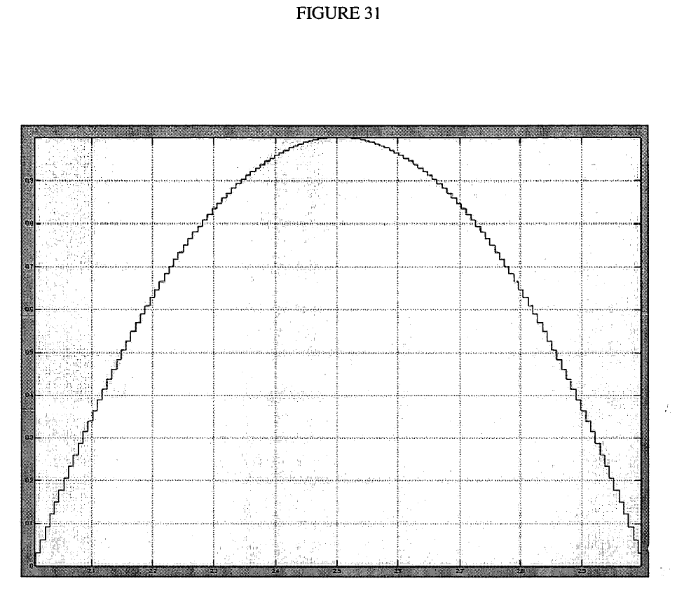

It is also possible to implement the L-pulse without using multipliers, although the appropriate circuit should include a rectifier (taking an absolute value) in addition to several unit delay elements and binary adders. For n=128 such a circuit is shown in FIG. 29. This circuit was actually used in the BER test simulator generating a train of L-pulses with a magnitude of 1 and a period of 1. The circuit includes three window integrators of the lengths 64, 64, and 127 samples; a rectifier; a delay element of the length of 128 samples; and a discrete pulse generator with the magnitude of 512, period of 256 samples, phase delay of 63 samples, and pulse width of 1 sample. It generates the pulse train shown in FIG. 30. This circuit starts generating the right kind of pulses after 256 initial samples. An example of an L-pulse so generated is shown in FIG. 31. Generating a train of L-pulses of the magnitude of 1 and the period of 1 on the sampling rate of an even f requires a circuit with three window integrators of the lengths of f/2, f/2, and f−1 samples; a rectifier, a delay element of the length of f samples; and a discrete pulse generator with the magnitude of 4*f, period of 2*f samples, phase delay of f/2−1 sample, and a pulse width of 1 sample. Also, if using a sliding summer instead of each of the window integrators, the circuit should include an amplifier (gain) with the value of 1/f³.

At n=127 (or, equivalently, at T=1 second and the sampling rate of 1/128 Hz) the parameters of the circuit shown in FIG. 29 should be modified. The circuit should include three window integrators of the lengths 63, 64, and 127 samples; a rectifier; a delay element of the length of 127 samples; and a discrete pulse generator with the magnitude of 508, period of 254 samples, phase delay of 63 samples, and pulse width of 1 sample. To generate a train of L-pulses of the magnitude of 1 and the period of 1 on the sampling rate of an odd f, requires a circuit with three window integrators of the lengths of (f+1)/2, (f−1)/2, f samples; a rectifier, a delay element of the length of f samples; and a discrete pulse generator with the magnitude of 4*f, period of 2*f samples, phase delay of (f−1)/2 sample, and a pulse width of 1 sample. Also, if using a sliding summer instead of each of the window integrators, the circuit should include an amplifier (gain) with the value of 1/f³.

BER test simulators were developed for SAS approximations of the Hanning and Blackman pulses. The results obtained were almost identical (i.e. differed by no more than 3 or 4 errors in each run) to those obtained for the original Hanning and Blackman pulses.

Data Windows Corresponding to the Pulses Introduced

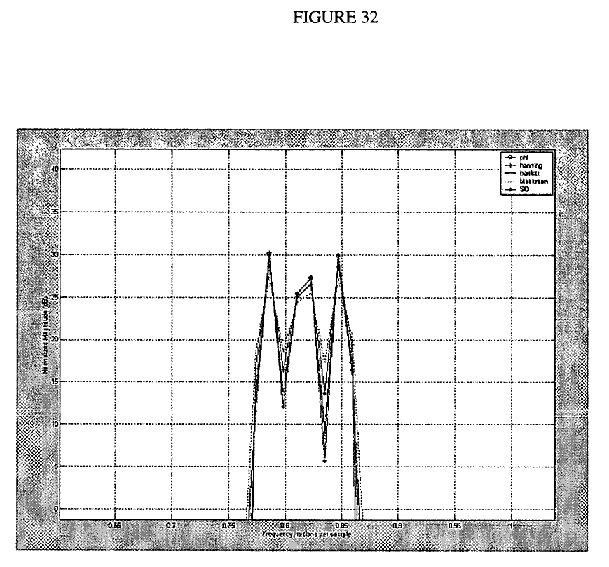

Compare the new pulses to the existing ones with respect to their windowing properties. If a fragment of a time series is used to analyze its spectrum, it is multiplied by a windowing function, and the spectrum of the product is then evaluated. A standard test of quality of a windowing function consists in evaluating a spectrum of a sum of several sine waves with close frequencies using a short fragment of the corresponding time series. FIG. 32 shows the spectral density of a sum of three sine waves of a unit magnitude with frequencies 1.135, 1.13, and 1.125 radians per sample using 512 samples. The L-pulse is the best and the phi-pulse is the second best with respect to distinguishing between the peaks corresponding to these sine waves on the periodogram.

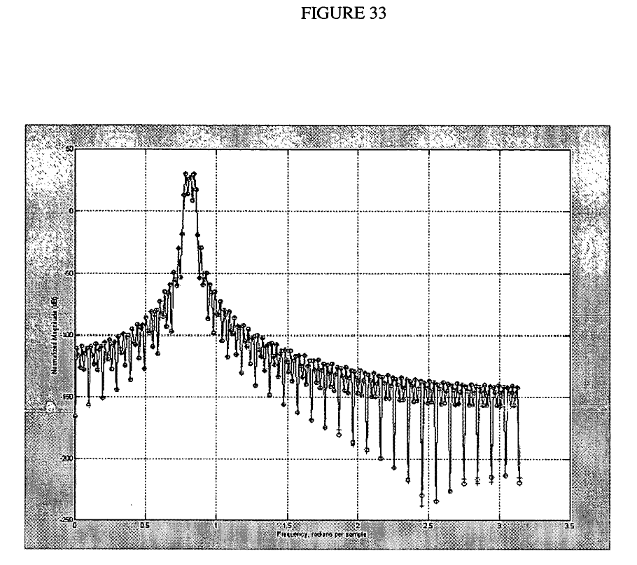

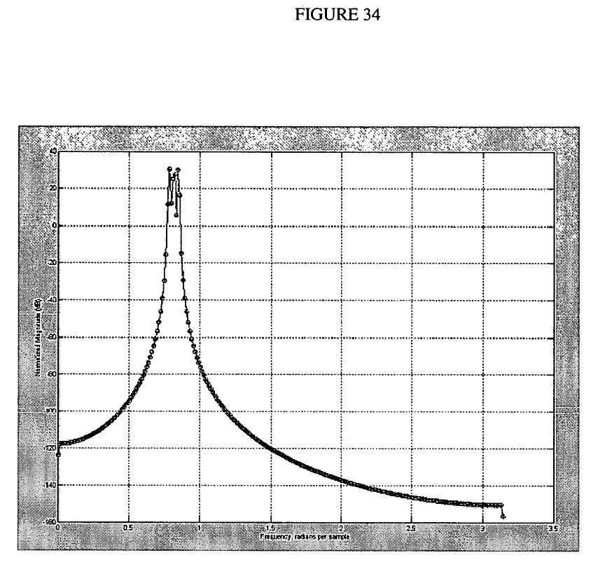

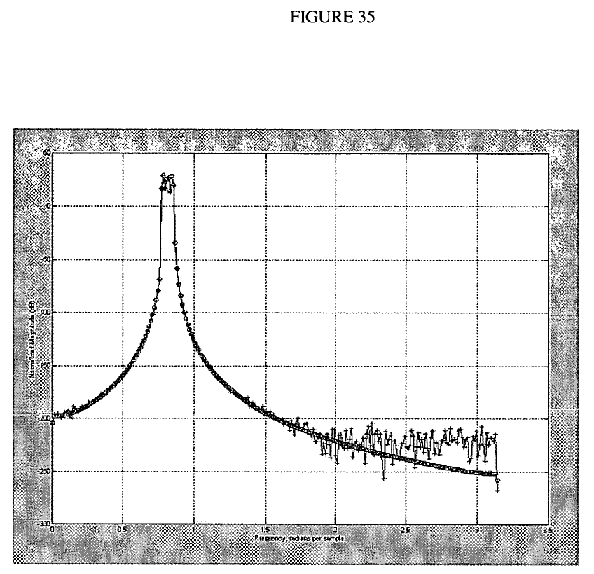

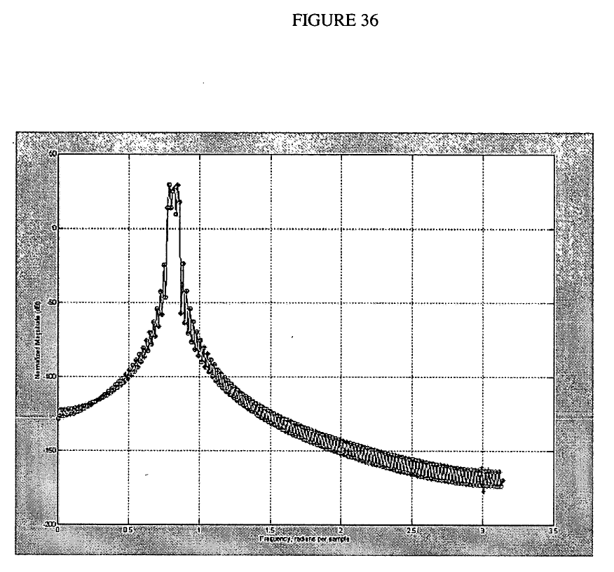

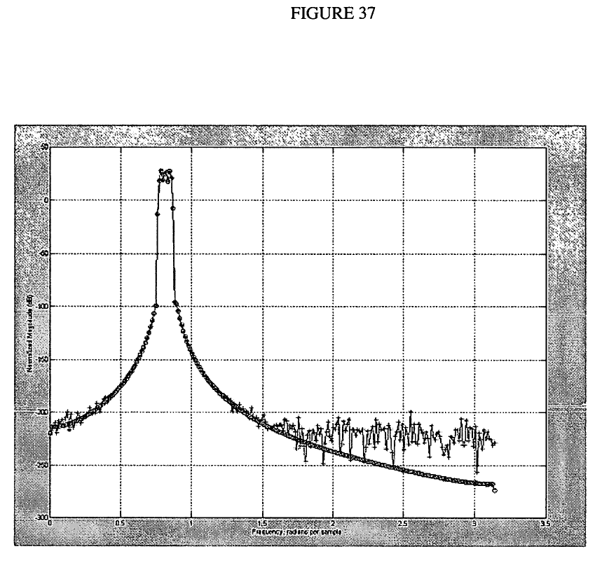

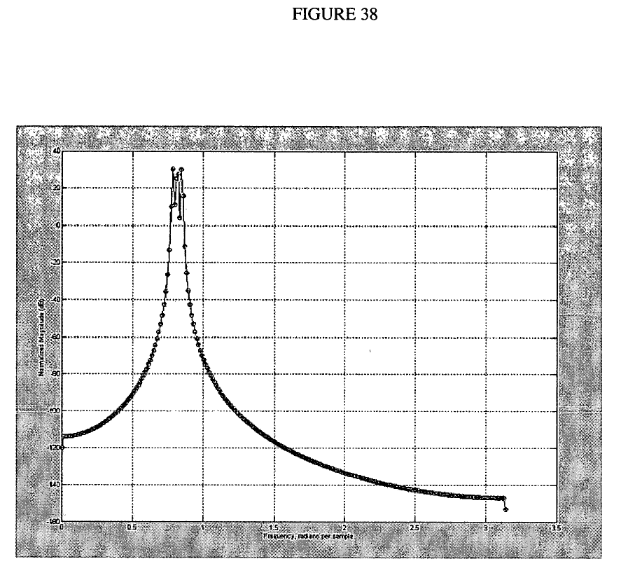

Another test of quality of a windowing function consists in evaluating its performance deterioration after applying a quantizer of a certain resolution q to its values. FIGS. 33 to 38 show spectral densities of the above mentioned sum of sine waves without quantization (circles) and upon applying a quantizer with the resolution of le-5, for phi-pulse, SO-pulse, Hanning pulse, Bartlett pulse, Blackman pulse, and L-pulse, respectively. This test shows that quantization does not affect the phi-pulse, SO-pulse, nor the L-pulse, unlike the Hanning and Blackman pulses.

Raised Pulses

Finally, it is possible to introduce ‘raised’ pulses using the ‘non-raised’ pulses presented above. Specifically, the well known Hamming pulse can be obtained from another well known Hanning pulse by multiplying the latter by 0.92 and adding 0.08. A similar transformation applied to the phi-pulse, L-pulse, and SO-pulse yields the following continuous representations of their raised counterparts:
0≦t≦3T/8: s=0.08A+736At/300T
3T/8<t<5T/8: s=A (17)
5T/8≦t≦T: s=760A/300−736At/300T

$$\begin{matrix}0 \leq t \leq T \text{:} s = 0.08 A + 3.68 A \frac{Tt - {t}^{2}}{{T}^{2}} & ( 18 ) \\ 0 \leq t \leq T \text{:} s = 0.08 A + 0.92 A sin \frac{π t}{T} & ( 19 )\end{matrix}$$

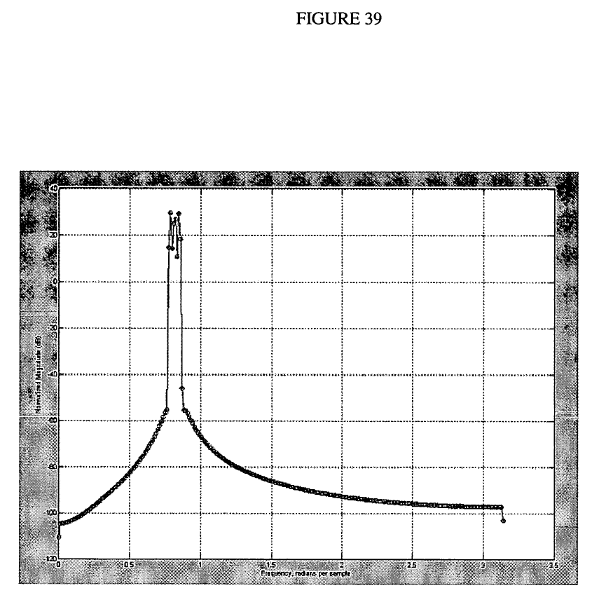

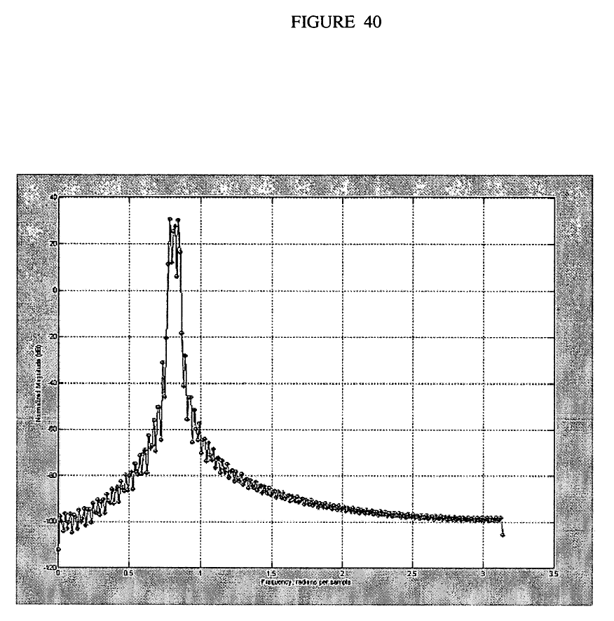

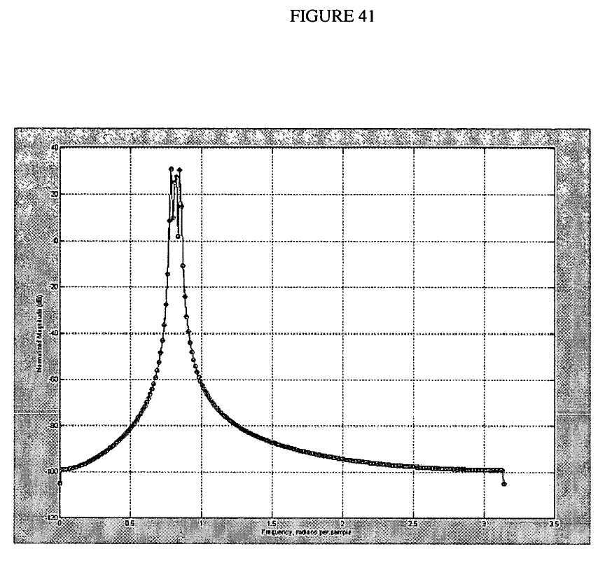

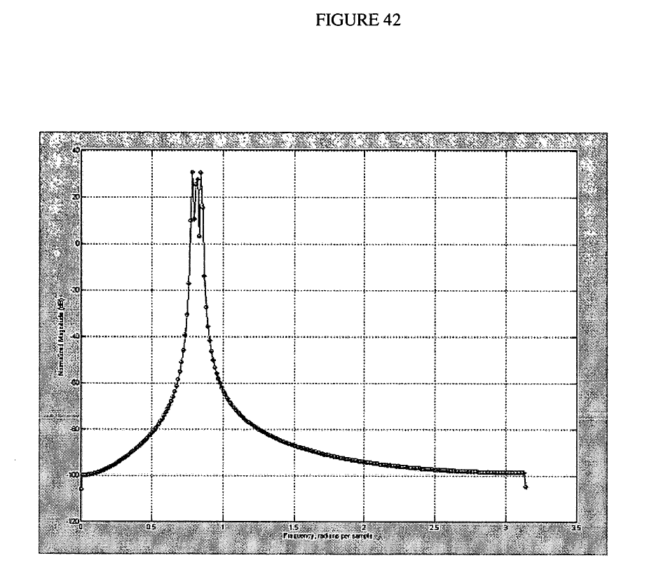

FIGS. 39, 40, 41, and 42 present spectral densities of a sum of 3 sine waves with frequencies specified earlier without quantization (“o”) and with quantization level of le-5 (“+”), for the Hamming pulse, raised phi-pulse, raised L-pulse, and raised SO-pulse, respectively.

Depending on specific requirements of a communication system a designer should choose one of the new pulses described in this document based on their PAPR values, J values, BER performance, and processing complexity.

### REFERENCES

1. Proakis, J. G., Digital Communications 3^{rd} Edition, McGraw-Hill, New York, 1995, pp. 233-248.
2. Korn, G. A., and Korn, T. M., Mathematical Handbook for Scientists & Engineers, Dover, N.Y., 2000, pp. 344-356.
3. Rorabaugh, C. B., DSP Primer, McGraw-Hill, New York, 1998, pp. 181-205.
4. Wheatley, III, Charles E., and Attar, Rashid A., Method and Apparatus for Peak to Average Power Reduction, U.S. Pat. No. 6,741,661; May 25, 2004.
5. Acharya, Tinku, and Miao, George J., Square Root Raised Cosine Symmetric Filter for Mobile Telecommunications, U.S. Pat. No. 6,731,706; May 4, 2004.
6. Steel, Francis R., Leitch, Clifford D., and Suarez, Jose I., Spectrally Efficient Digital Modulation Method and Apparatus, U.S. Pat. No. 4,737,969, Apr. 12, 1988.
7. Dayton, Birney D., Sine-Squared Pulse Shaping Circuit, U.S. Pat. No. 4,311,921, Jan. 19, 1982.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A method of generating low-complexity, spectrally efficient pulses for digital communications comprising:
means for selecting said spectrally efficient pulses in accordance with an optimization criterion;
means for communications employing said spectrally efficient pulses; and
means for data processing employing said spectrally efficient pulses.

2. The method of claim 1 wherein said means for selecting spectrally efficient pulses in accordance with an optimization criterion comprises minimizing the pulse spectral width on a certain class of pulses.

3. The method of claim 2 wherein said class of pulses comprises pulses of predefined period and area.

4. The method of claim 3 wherein said spectrally efficient pulses have the following continuous representation:
$$0 \leq t \leq T \text{:} s = A sin \frac{π t}{T}$$
where s is the pulse value at the time t;
A is the pulse magnitude; and
T is the pulse period.

5. The method of claim 2
wherein said class of pulses comprises pulses generated by passing a unit area impulse through a sequence of sliding summers with a predefined length;
each of said sliding summers is a sequence of connected pairs;
each of said pairs comprises a binary adder and a unit delay element; and
said length is the number of said connected pairs in all of said sliding summers.

6. The method of claim 5 wherein said spectrally efficient pulses have the following continuous representation:
0≦t≦3T/8: s=8At/3T
3T/8<t<5T/8: s=A
5T/8≦t≦T: s=8A/3−8At/3T
where s is the pulse value at the time t;
A is the pulse magnitude; and
T is the pulse period.

7. The method of claim 3 wherein said spectrally efficient pulses have the following continuous representation:
$$0 \leq t \leq T \text{:} s = A \frac{4 Tt - 4 {t}^{2}}{{T}^{2}}$$
where s is the pulse value at the time t;
A is the pulse magnitude; and
T is the pulse period.

8. The method of claim 1 wherein said means for communications comprises:
generating a train of said spectrally efficient pulses;
multiplying each spectrally efficient pulse by a symbol from an information-bearing sequence;
transmitting and receiving the result of said multiplying; and
retrieving said symbol from the result of said multiplying.

9. The method of claim 8 wherein said retrieving comprises using an optimal correlator type of receiver.

10. The method of claim 5 further comprising an optimal approximation of an existing pulse by one from said class.

11. The method of claim 10 wherein said existing pulse is the Hanning pulse.

12. The method of claim 10 wherein said existing pulse is the Blackman pulse.

13. The method of claim 1 wherein said means for data processing comprises:
multiplying a fragment of a time series by a window function and estimating the spectrum of said time series from said fragment;
wherein said window function is one of said spectrally efficient pulses.

14. The method of claim 3 wherein said spectrally efficient pulses have the following continuous representation:
$$0 \leq t \leq T \text{:} s = 0.08 A + 0.92 A sin \frac{π t}{T}$$
where s is the pulse value at the time t;
A is the pulse magnitude; and
T is the pulse period.

15. The method of claim 5 wherein said spectrally efficient pulses have the following continuous representation:
0≦t≦3T/8: s=0.08A+736At/300T
3T/8<t<5T/8: s=A
5T/8≦t≦T: s=760A/300−736At/300T
where s is the pulse value at the time t;
A is the pulse magnitude; and
T is the pulse period.

16. The method of claim 3 wherein said spectrally efficient pulses have the following continuous representation:
$$0 \leq t \leq T \text{:} s = 0.08 A + 3.68 A \frac{Tt - {t}^{2}}{{T}^{2}}$$
where s is the pulse value at the time t;
A is the pulse magnitude; and
T is the pulse period.

17. The method of claim 1 wherein said means for communications comprises comparing the BER values of two pulses without performing BER tests.

18. The method of claim 17 comprising:
calculating the ratio of spectral widths of said pulses;
calculating the square of said ratio; and
estimating the ratio of said BER values as said square.

19. The method of claim 18 wherein said BER values are averaged over an actual range of pulse timing errors.
